(19) United States
(12) Patent Application Publication
(10) Pub. No.: US 2014/0377676 A1
(43) Pub. Date: Dec. 25, 2014

(54) FUEL CELL SYSTEM

(71) Applicant: PANASONIC CORPORATION, Osaka (JP)

(72) Inventors: Hiroaki Matsuda, Osaka (JP); Isamu Kawata, Osaka (JP)

(21) Appl. No.: 14/378,317

(22) PCT Filed: Nov. 26, 2013
(86) PCT No.: PCT/JP2013/006932

§ 371 Date: Aug. 12, 2014

(30) Foreign Application Priority Data
Mar. 11, 2013 (JP) 2013-048262

(51) Int. Cl. H01M 8/04

(52) U.S. Cl. CPC H01M 8/04097; H01M 8/04201
USPC 429/415

(57) ABSTRACT

A fuel cell system includes: a fuel cell to consume a fuel and generate electric power; a feeder for feeding a circulating fluid including the fuel to the cell; a collector for collecting the circulating fluid including unconsumed fuel from the cell; a first channel connecting the cell with the collector; a second channel connecting the collector with the feeder; and a third channel connecting the feeder with the cell. A mass ratio M2/M1 is less than or equal to 20 ppm in terms of hexadecane, where M1 is a total mass of the collector and the first, second and third channels, and M2 is a mass of organic substances eluted into the circulating fluid or an equivalent therefor, while the collector and the first, second and third channels are immersed in the circulating fluid or equivalent at a temperature TH1 for a certain time.

### TECHNICAL FIELD

The present invention relates to a technique for suppressing deterioration in performance over time of a fuel cell system including a direct oxidation fuel cell that consumes liquid fuel such as methanol and generates electric power.

### BACKGROUND ART

Fuel cells are devices that generate electric power through an electrochemical reaction. As compared with power generation devices utilizing a heat engine, fuel cells can generate power with high efficiency because of not depending on the Carnot efficiency. Moreover, fuel cells produce less noise and vibration, and thus are expected to be widely used as power generation devices for consumer use, such as outdoor use. In particular, direct oxidation fuel cells utilizing methanol as fuel, such as direct methanol fuel cells (DMFCs), can be easily reduced in size. Therefore, they are also expected to be developed as a power source for portable equipment.

However, particularly when an organic fuel such as methanol is utilized as fuel of fuel cells, elution of impurities such as organic substances into fuel from a fuel tank can be a problem. In this regard, Patent Literature 1 suggests that a linear polyethylene with specific properties be used as a material of the fuel tank, thereby to suppress the elution of impurities into fuel from the fuel tank.

### CITATION LIST

### Patent Literature

[PTL 1] Japanese Laid-Open Patent Publication No. 2010-242077

### SUMMARY OF INVENTION

### Technical Problem

As mentioned above, Patent Literature 1 suggests controlling the material of the fuel tank, thereby to suppress the elution of organic substances as impurities into fuel. If such impurities enter the fuel, due to its influence, for example, the catalyst of the anode serving as the fuel electrode may deteriorate, causing the output of the fuel cell to decline. Therefore, it is important to select a material from which impurities are unlikely to elute, as the material of the fuel tank. The present inventors have studied on this matter and found, however, that the decline in output over time sometimes cannot be sufficiently suppressed only by the method suggested by Patent Literature 1.

An object of the present invention therefore is to provide a fuel cell system capable of suppressing the decline in output over time of the fuel cell caused by entry of organic substances as impurities into fuel.

### Solution to Problem

One aspect of the present invention relates to a fuel cell system including:

a fuel cell configured to consume a fuel and generate electric power;

a fuel feeder for feeding a circulating fluid including the fuel to the fuel cell;

a collector for collecting the circulating fluid that is discharged from the fuel cell and includes the fuel unconsumed by the fuel cell;

a first fluid flow channel connecting the fuel cell with the collector;

a second fluid flow channel connecting the collector with the fuel feeder; and

a third fluid flow channel connecting the fuel feeder with the fuel cell, in which

a ratio M2/M1 of a mass M2 to a mass M1 is less than or equal to 20 ppm in terms of hexadecane, where the mass M1 is a total mass of the collector, the first fluid flow channel, the second fluid flow channel and the third fluid flow channel, and the mass M2 is a mass of organic substances eluted into the circulating fluid or an equivalent for the circulating fluid, while the collector, the first fluid flow channel, the second fluid flow channel and the third fluid flow channel are immersed in the circulating fluid or the equivalent at a temperature TH1 for a time period TM1.

Another aspect of the present invention relates to a fuel circulating system for fuel cell system. The circulating system includes:

a collector for collecting a circulating fluid that is discharged from a fuel cell and includes unconsumed fuel;

a first fluid flow channel connecting the fuel cell with the collector;

a second fluid flow channel connecting the collector with a fuel feeder for feeding the circulating fluid to the fuel cell; and

a third fluid flow channel connecting the fuel feeder with the fuel cell, in which

a ratio M2/M1 of a mass M2 to a mass M1 is less than or equal to 20 ppm in terms of hexadecane, where the mass M1 is a total mass of the collector, the first fluid flow channel, the second fluid flow channel and the third fluid flow channel, and the mass M2 is a mass of organic substances eluted into the circulating fluid or an equivalent for the circulating fluid, while the collector, the first fluid flow channel, the second fluid flow channel and the third fluid flow channel are immersed in the circulating fluid or the equivalent at a temperature TH1 for a time period TM1.

### Advantageous Effects of Invention

According to the present invention, by controlling the mass of organic substances as impurities entering the fuel in the fuel circulation system to be less than or equal to a reference value, the decline in output of the fuel cell caused by the impurities can be suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic block diagram of a fuel cell system according to one embodiment of the present invention

FIG. 2 A cross-sectional view of a basic structure of a fuel cell used for the system of FIG. 1

FIG. 3 A graph showing a relationship between the amount of organic substances as impurities eluted into the circulating fluid and the output decline rate of the fuel cell system

### DESCRIPTION OF EMBODIMENTS

The prevent invention relates to a fuel cell system including: a fuel cell configured to consume a fuel and generate electric power; a fuel feeder for feeding a circulating fluid including the fuel to the fuel cell; a collector for collecting the circulating fluid discharged from the fuel cell and including the fuel unconsumed by the fuel cell; a first fluid flow channel connecting the fuel cell with the collector; a second fluid flow channel connecting the collector with the fuel feeder; and a third fluid flow channel connecting the fuel feeder with the fuel cell. The fuel feeder is, for example, a fluid feed pump (liquid pump) for feeding the circulating fluid to the fuel cell. The collector is, for example, a container or a tank. The fluid flow channel is, for example, a piping such as a tube and a pipe. The piping is usually a product of molded resin. Joints and other parts of the piping may be metals.

The fuel is, for example, methanol. When the fuel is methanol, the circulating fluid is, for example, an aqueous methanol solution. The fuel flows from a fuel tank, which is installed separately, into the fuel feeder, where the fuel flow meets the circulating fluid flow.

The total mass of the collector, the first fluid flow channel, the second fluid flow channel and the third fluid flow channel is denoted as “M1”. In an appropriate container (e.g., glass container), which is prepared separately, an appropriate mass of circulating fluid (e.g., circulating fluid having a composition similar to that of the circulating fluid within a path from the collector to a second fluid flow channel 24) is placed, and the temperature thereof is held at TH1. For example, the collector, the first fluid flow channel, the second fluid flow channel and the third fluid flow channel are respectively cut in pieces (hereinafter collectively referred to as “test articles”) having an appropriate size (size that can be placed in the container), and those pieces are immersed in the circulating fluid in the container. At this time, it is preferable to remove powdered test articles or very small fragments of the test articles, if any, so that they will not enter the container. By testing with the pieces having an appropriate size only, it is possible to test under the conditions similar to those when the collector and other components are actually used in the fuel cell. The metals such as joints should be removed.

After immersed in the circulating fluid for the time period TM1, the test articles are taken out of the container. Then, the circulating fluid remaining in the container is subjected to, for example, gas chromatograph/mass spectrometry (GC/MS), to detect an amount of organic substances as impurities eluted from the test articles. Specifically, a ratio α: M2/M1 of a mass M2 of organic substances as impurities eluted into the circulating fluid (hereinafter referred to as “eluted impurities”) to the mass M1 is determined. In the fuel cell system of the present invention, a material in which the ratio α (hereinafter sometimes simply referred to as “mass ratio”) is less than or equal to 20 ppm in terms of hexadecane is used to form the collector, the first fluid flow channel, the second fluid flow channel, and the third fluid flow channel.

Here, 20 ppm is a reference value determined by experiment, and when the mass ratio α of the eluted impurities exceeds the reference value, the decline in output of the fuel cell increases acceleratedly as shown in FIG. 3. Therefore, by using a material in which the mass ratio α of the eluted impurities as measured by the aforementioned test is less than or equal to the reference value to form the collector and the first, second and third fluid flow channels, the decline in output of the fuel cell can be suppressed. In other words, for example, in addition to suppressing the elution of impurities into fuel from a fuel tank by controlling the material of the fuel tank (including a cartridge tank) as disclosed in Patent Literature 1, reducing the eluted impurities into fuel from the collector and others can effectively suppress the decline in output of the fuel cell.

The reason why the decline in output of the fuel cell increases acceleratedly when the mass ratio α of the eluted impurities exceeds the reference value is presumably as follows. As compared with a fuel such as methanol with comparatively small molecular weight, impurities such as organic substances (e.g., antioxidant, plasticizer, and lubricant) with large molecular weight will be directly discharged from the anode without diffusing into the anode catalyst and merely circulate, unless the concentration of eluted impurities in the circulating fluid reaches a certain concentration or higher. When the concentration of eluted impurities in the circulating fluid exceeds such a concentration, the eluted impurities start reaching the anode catalyst, and from that moment, the decline in output of the fuel cell increases sharply. In short, the decline in output of the fuel cell does not linearly increase against the concentration of eluted impurities in the circulating fluid, but starts to increase sharply from the moment when the concentration of eluted impurities in the circulating fluid exceeds a predetermined concentration. In the present invention, the reference value of the mass ratio α, which is closely related to the above concentration, is properly set with respect to the collector and the first, second and third fluid flow channels, for the purpose of effectively suppressing the decline in output of the fuel cell. In other words, among the fuel feeder (e.g., fluid feed pump), the collector and the first, second and third fluid flow channels constituting the fuel circulation line, the present invention particularly optimizes the materials of the collector and the first, second and third fluid flow channels (hereinafter sometimes referred to as “fuel circulating system”) using the above-described reference value, since these materials are usually products of molded resin.

It is to be noted that a fuel tank (including a cartridge tank) and a fuel introducing conduit for introducing fuel from the fuel tank to the fuel feeder are portions which are to contact with highly concentrated fuel. For these portions, countermeasures are usually taken already against the eluted impurities, and therefore, with regard to the eluted impurities therein, the influence thereof need not be taken into account. The same applies to a fluid feed pump into which highly concentrated fuel flows from the fuel tank, and to a fuel pump for supplying fuel from the fuel tank to the fluid feed pump. The present invention is supposed to be applied to such an ordinary system.

On the other hand, the circulating fluid, which is discharged from the fuel cell, is low in fuel concentration, but is high in temperature and low in power of hydrogen (pH), as compared with the fluid introduced from the fuel tank. Therefore, with regard to the portions of the fuel circulating system through which the circulating fluid flows, adverse influence of the eluted impurities need be evaluated under special test conditions which are different from those for evaluating the fuel tank and other similar components. The present invention supposes that, with regard to the eluted impurities from the fuel cell itself, too, the influence thereof need not be taken into account, since an appropriate material (e.g., carbon) is already selected as the material forming the fuel flow channel within the fuel cell.

Here, a mass M3 of the circulating fluid used in the aforementioned test is preferably 20 times or more and 40 times or less as much as the total mass M1 of the collector and the first, second and third fluid flow channels. The temperature TH1 of the circulating fluid during the test is preferably 60° C. or higher and 80° C. or lower. The time period TM1 during which impurities are allowed to elute from the test article is preferably 40 hours or more and 60 hours or less. By setting the test conditions as above, the test can be performed under the conditions more similar to the actual operating conditions of the fuel cell and with less margin of error. This can reliably suppress the decline in output of the fuel cell.

Here, as for the collector and the first, second and third fluid flow channels, products of molded resin may be used.

Furthermore, the circulating fluid used for the above test is preferably an equivalent for the circulating fluid. An equivalent for the circulating fluid in DMFCs is, for example, an aqueous solution containing methanol and formic acid and having a power of hydrogen (pH) of 3. Formic acid is a by-product of a methanol oxidation reaction in DMFCs, which reduces the pH of the circulating fluid to around 3. The methanol concentration in the equivalent is 2 mass %, and the formic acid concentration is 300 ppm by mass.

The present invention relates to a fuel circulating system for fuel cell system. The fuel circulating system includes: a collector for collecting a circulating fluid discharged from a fuel cell and including unconsumed fuel; a first fluid flow channel connecting the fuel cell with the collector; a second fluid flow channel connecting the collector with a fuel feeder for feeding the circulating fluid to the fuel cell; and a third fluid flow channel connecting the fuel feeder with the fuel cell. The system does not include the fuel cell itself and a fuel feeder (e.g., fluid feed pump). A ratio α: M2/M1 of a mass M2 to a mass M1 is less than or equal to 20 ppm in terms of hexadecane, where the mass M1 is a total mass of the collector, the first fluid flow channel, the second fluid flow channel and the third fluid flow channel, the mass M2 is a mass of organic substances eluted into the circulating fluid or an equivalent for the circulating fluid, while the collector, the first fluid flow channel, the second fluid flow channel and the third fluid flow channel are immersed in the circulating fluid or the equivalent at a temperature TH1 for a time period TM1.

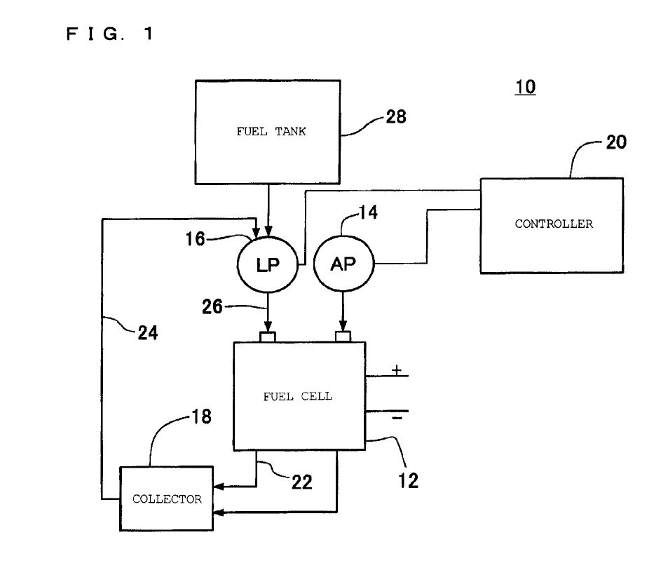

In the following, an embodiment of the present invention will be described with reference to the drawings. FIG. 1 is a schematic block diagram of a fuel cell system according to one embodiment of the present invention. The illustrated fuel cell system 10 includes a fuel cell 12 which is a direct oxidation fuel cell (DMFC). The fuel cell 12 includes a cathode (oxidant electrode) and an anode (fuel electrode) (both not shown). The fuel cell 12 consumes methanol as a fuel and an oxidant to generate electric power.

The fuel cell system 10 further includes: an air pump 14 for supplying air serving as the oxidant to the cathode; a fluid feed pump (fuel feeder) 16 for supplying a circulating fluid including the fuel to the anode; a collector 18 for collecting an anode fluid (circulating fluid) discharged from the anode and including the fuel unconsumed by the fuel cell, and a cathode fluid discharged from the cathode; a controller 20 for controlling the fluid feed pump 16 and the air pump 14; and a fuel tank 28. The collector 18 may be a container or a tank. The fluid feed pump 16, for example, sucks the fuel from the fuel tank 28, and supplies the fuel mixed with the circulating fluid, to the anode. Separately from the fluid feed pump 16, a fuel pump (not shown) for feeding the fuel from the fuel tank 28 to the fluid feed pump 16 may be disposed between the fuel tank 28 and the fluid feed pump 16.

The anode of the fuel cell 12 is connected to the collector 18 by a first fluid flow channel 22. The controller 18 is connected to the fluid feed pump 16 by a second fluid flow channel 24. The fluid feed pump 16 is connected to the anode of the fuel cell 12 by a third fluid flow channel 26. A circulating fluid discharged from the anode of the fuel cell 12, which includes unconsumed fuel and carbon dioxide being a reaction by-product, is transferred from the fuel cell 12 to the collector 18, through the first fluid flow channel 22. The collector 18 collects a cathode fluid discharged from the cathode of the fuel cell 12, which includes water being a reaction by-product.

The first fluid flow channel 22, the second fluid flow channel 24, and the third fluid flow channel 26 may be a piping, such as a tube and a pipe, being a resin molded product. Exemplary materials of the first, second and third fluid flow channels 22, 24 and 26 include polyethylene (PE), polypropylene (PP), polyphenylene sulfide (PPS), tetrafluoroethylene-perfluoroalkyl vinylether copolymer (PFA), tetrafluoroethylene-hexafluoropropylene copolymer (FEP), polyether Imide (PEI), modified PPE (polyphenylene ether), glass fiber-reinforced epoxy resin, glass fiber-reinforced PPS (polyphenylene sulfide), silicone rubber, and fluorine rubber.

The collector 18 may be, for example, a container, or a tank, being a resin molded product. Exemplary materials of the collector 18 include PE, PP, PPS, PFA, FEP, PEI, modified PPE, glass epoxy, and glass fiber-reinforced PPS.

At the collector 18, all or part of the unconsumed oxidant and carbon dioxide is separated from the circulating fluid and discharged outside. On the other hand, all or part of the unconsumed fuel and water is collected, and transferred as the circulating fluid, from the collector 18 to the fluid feed pump 16 through the second fluid flow channel 24. At the fluid feed pump 16, the circulating fluid from the collector 18 is mixed with the fuel from the fuel tank 28. A circulating fluid produced by the mixing is transferred through the third fluid flow channel 26 to the fuel cell 12. The fluid feed pump 16, the collector 18, and the first, second and third fluid flow channels 22, 24 and 26 are referred to as “circulation line”. The circulation line is for circulating the circulating fluid through the fuel cell 12. Of the circulation line, the collector 18 and the first, second and third fluid flow channels 22, 24 and 26 are referred to as “fuel circulating system”. In the present embodiment, the amount of organic substances eluted as impurities from the constituent elements of the fuel circulating system into the circulating fluid is a subject to be controlled. The organic substances as impurities eluted into the circulating fluid in the fuel circulating system basically keep circulating within the system, without being discharged outside.

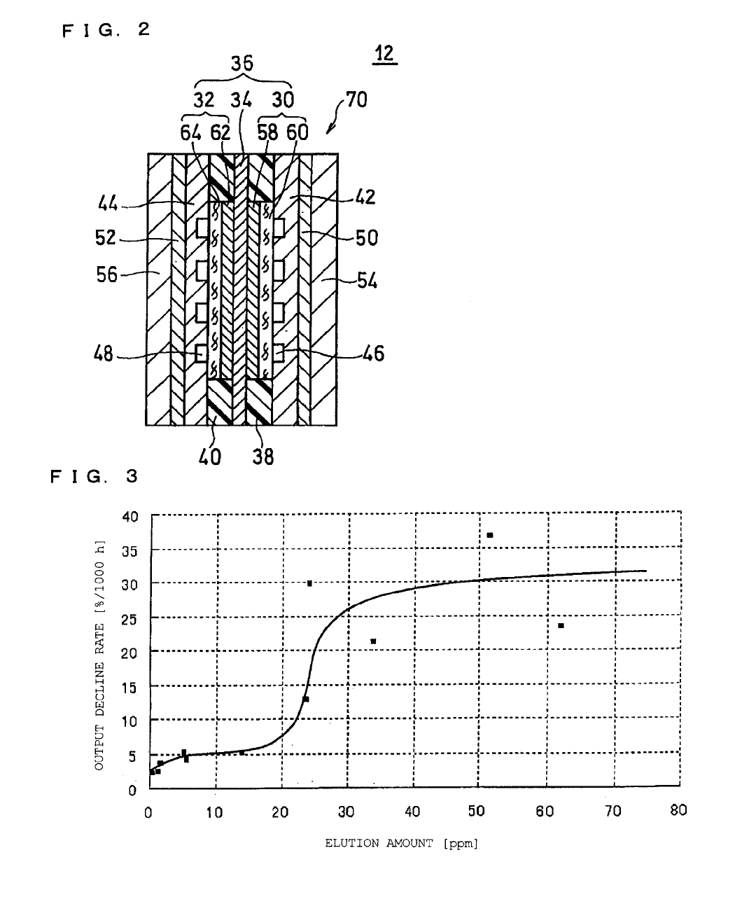

FIG. 2 is a cell (unit cell) constituting the fuel cell 12. A cell 70 has a membrane electrode assembly (MEA) 36 including an anode 30, a cathode 32, and an electrolyte membrane 34 interposed between the anode 30 and the cathode 32. On one side of the MEA 36, a gasket 38 is disposed so as to seal the anode 30; on the other side thereof, a gasket 40 is disposed so as to seal the cathode 32.

The MEA 36 is sandwiched between an anode-side separator 42 and a cathode-side separator 44. The anode-side separator 42 is in contact with the anode 30; the cathode-side separator 44 is in contact with the cathode 32. The anode-side separator 42 has a fuel flow path 46 for supplying a fuel to the anode 30. The fuel flow path 46 has an anode inlet through which the fuel enters, and an anode outlet through which CO₂ produced by the reaction and unused fuel are discharged.

The cathode-side separator 44 has an oxidant flow path 48 for supplying an oxidant to the cathode 32. The oxidant flow path 48 has a cathode inlet through which the oxidant enters, and a cathode outlet through which water produced by the reaction and unused oxidant are discharged. On the anode-side and cathode-side separators 42 and 44, current collector plates 50 and 52 are disposed, respectively, on which end plates 54 and 56 are further disposed, respectively. The end plates 54 and 56 are fastened to each other, and thereby the cell 70 is held therebetween. Heaters for temperature adjustment may be stacked on the outsides of the end plates 54 and 56.

The fuel cell 12 may include a plurality of the cells 70. The cells 70 are, for example, connected in series and stacked together, into a fuel cell stack. In this case, the anode-side separator 42 and the cathode-side separator 44 are usually formed as one integral member. Specifically, one side of one separator serves as the anode-side separator, on which the fuel flow path 46 is formed. The other side of the one separator serves as the cathode-side separator, on which the oxidant flow path 48 is formed. The anode inlets of the cells are usually converged into one by, for example, using a manifold. Likewise, the anode outlets, the cathode inlets, and the cathode outlets are respectively converged into one.

Next, a detailed description will be given of the components of the cell, with reference to FIG. 2. The components of the cell, however, should not be limited to the following.

The cathode 32 includes a cathode catalyst layer 62 contacting the electrolyte membrane 34, and a cathode diffusion layer 64 contacting the cathode-side separator 44. The cathode diffusion layer 64 includes, for example, a conductive water-repellent layer (not shown) contacting the cathode catalyst layer 62, and a substrate layer (not shown) contacting the cathode-side separator 44.

The cathode catalyst layer 62 includes a cathode catalyst and a polymer electrolyte. The cathode catalyst is preferably a noble metal such as platinum (Pt) with high catalytic activity. The cathode catalyst may be used with or without a support. The support is preferably a carbon material such as carbon black, since it has high electron conductivity and high resistance to acids. The polymer electrolyte is preferably a proton conductive material, such as a perfluorosulfonic acid polymer material and a hydrocarbon polymer material. Examples of the perfluorosulfonic acid polymer material include Nafion (registered trademark).

The anode 30 includes an anode catalyst layer 58 contacting the electrolyte membrane 34, and an anode diffusion layer 60 contacting the anode-side separator 42. The anode diffusion layer 60 includes, for example, a conductive water-repellent layer (not shown) contacting the anode catalyst layer 58, and a substrate layer (not shown) contacting the anode-side separator 42.

The anode catalyst layer 58 includes an anode catalyst and a polymer electrolyte. The anode catalyst is preferably a platinum-ruthenium (Pt—Ru) alloy catalyst, in view of reducing catalyst poisoning by carbon monoxide. The anode catalyst may be used with or without a support. The support may be a carbon material similar to that used for the cathode catalyst. The polymer electrolyte included in the anode catalyst layer 58 may be a material similar to that used for the cathode catalyst layer 62.

The conductive water-repellent layers included in the anode and cathode diffusion layers 60 and 64 each include a conductive agent and a water repellent agent. The conductive agent included in the conductive water-repellent layer may be, without limitation, any material commonly used in the field of fuel cells, such as carbon black. The water repellent agent included in the conductive water-repellent layer may be, without limitation, any material commonly used in the field of fuel cells, such as polytetrafluoroethylene (PTFE).

The substrate layer is made of a conductive porous material. The conductive porous material may be, without limitation, any material commonly used in the field of fuel cells, such as carbon paper. The porous material may contain a water repellent agent in order to facilitate the diffusion of fuel and removal of product water. The water repellent agent may be a material similar to that included in the conductive water-repellent layer.

The electrolyte membrane 34 may be, without limitation, any conventionally-used proton conductive polymer membrane. Preferable examples thereof include a perfluorosulfonic acid polymer membrane and a hydrocarbon polymer membrane. Examples of the perfluorosulfonic acid polymer membrane include Nafion (registered trademark).

Examples of preferable embodiments of the present invention will be described below. The present invention, however, should not be limited to the following examples.

### Example 1

Silicone rubber tubes (available from A1 company) each having an outer diameter of 7 mm, an inner diameter of 3 mm, and an overall length of 130 mm, and having a total weight of 50 g (denoted as “Ma1”) were used as the first, second and third fluid flow channels. A polyethylene (PE) tank (available from B1 company) having a weight of 250 g (denoted as “Mb1”) was used as the collector. The silicone rubber tubes were cut to prepare a plurality of test articles of about 5 cm in length (hereinafter referred to as “tube test articles”). Likewise, the PE tank was cut to prepare a plurality of test articles of about 3×5 cm in size (hereinafter referred to as “tank test articles”). The total weight of the tube test articles and the tank test articles corresponds to the mass M1.

An aqueous methanol and formic acid solution having a power of hydrogen (pH) of 3 was prepared as a test circulating fluid (equivalent for circulating fluid). The methanol concentration in the test circulating fluid was set to 2%, and the formic acid concentration was set to 300 ppm. The test circulating fluid weighed in an amount 30 times as much as the total weight of the tube test articles was placed in a glass beaker (C11), and heated to 70° C. The beaker was placed in a heat-insulation chamber, and the temperature of the test circulating fluid was kept at 70° C. The tube test articles were placed in the beaker, and all the tube test articles were immersed in the test circulating fluid. In this state, they were left to stand for 50 hours.

The test circulating fluid weighed in an amount 30 times as much as the total weight of the tank test articles was placed in a glass beaker (C12), and heated to 70° C. The beaker was placed in a heat-insulation chamber, and the temperature of the test circulating fluid was kept at 70° C. The tank test articles were placed in the beaker, and all the tank test articles were immersed in the test circulating fluid. In this state, they were left to stand for 50 hours. The total weight of the test circulating fluid placed in the beaker (C11) and the test circulating fluid placed in the beaker (C12) corresponds to the mass M3.

After 50 hours, the test articles were taken out from the beakers. The test circulating fluid remaining in each beaker was analyzed by chromatograph/mass spectrometry (GC/MS), to detect a mass ratio α of the organic substances as impurities (eluted impurities) eluted from the test articles, to the test articles. More specifically, the mass ratio α of eluted impurities was determined by converting the sum of peak areas of impurities obtained by total ion chromatography (TIC) into the corresponding amount of hexadecane, using a calibration curve of hexadecane. The detected mass ratio α of eluted impurities (elution amount) was 1.6 ppm (referred to as “Ma2”) in the beaker (C11); and 1.8 ppm (referred to as “Mb2”) in the beaker (C12). The weighted average of them (elution amount weighted average=(Ma2×Ma1+Mb2×Mb1)/(Ma1+Mb1)) was approximately 1.6 ppm. The elution amount weighted average corresponds to the ratio (α): M2/M1.

A fuel cell system was constituted by using the same tubes as those used for preparing the tube test articles, to form first, second, and third flow channels, and using the same tank as that used for preparing the tank test articles, to form a collector. The output terminal of the fuel cell system was connected to an electronic load device, and the output thereof was measured. The fluid feed pump used here was a liquid pump for which measures were taken to allow the elution of impurities to be ignored. The fuel cell used here was a prototype having a rated output of 100 W for which measures were taken to allow the elution of impurities to be ignored. The fuel tank used here was a glass (e.g., quartz glass) container which is free of risk of impurity elution. A similar glass pipe was used for a fuel introducing conduit that connects the glass container with the fluid feed pump.

The fuel cell system was operated under the condition that the circulating fluid within the second fluid flow channel from the collector will have almost the same composition as the test circulating fluid. An output P1 at 1 hour after the start of operation and an output P2 at 1000 hours after the start of operation were measured, to determine an output decline rate: {(P1−P2)/P1}×100(%).

### Example 2

The mass ratio α of eluted impurities (the elution amount and the elution amount weighted average in each beaker) was detected in the same manner as in Example 1, except that the tube test articles were prepared from fluorine rubber tubes (available from A2 company), and the output decline rate of the fuel cell system was determined in the same manner as in Example 1.

### Example 3

The mass ratio α of eluted impurities was detected in the same manner as in Example 1, except that the tube test articles were prepared from PFA tubes (available from A3 company), and the output decline rate of the fuel cell system was determined in the same manner as in Example 1.

### Example 4

The mass ratio α of eluted impurities was detected in the same manner as in Example 1, except that the tank test articles were prepared from a PP tank (available from B2 company), and the output decline rate of the fuel cell system was determined in the same manner as in Example 1.

### Example 5

The mass ratio α of eluted impurities was detected in the same manner as in Example 1, except that the tank test articles were prepared from a modified PPE tank (available from B3 company), and the output decline rate of the fuel cell system was determined in the same manner as in Example 1.

### Example 6

The mass ratio α of eluted impurities was detected in the same manner as in Example 1, except that the tank test articles were prepared from a PPS tank (available from B4 company), and the output decline rate of the fuel cell system was determined in the same manner as in Example 1.

### Comparative Example 1

The mass ratio α of eluted impurities was detected in the same manner as in Example 1, except that the tube test articles were prepared from ethylene-propylene-diene rubber (EPDM) tubes (available from A4 company), and the output decline rate of the fuel cell system was determined in the same manner as in Example 1.

### Comparative Example 2

The mass ratio α of eluted impurities was detected in the same manner as in Example 1, except that the tube test articles were prepared from PE tubes (available from A5 company), and the output decline rate of the fuel cell system was determined in the same manner as in Example 1.

### Comparative Example 3

The mass ratio α of eluted impurities was detected in the same manner as in Example 1, except that the tube test articles were prepared from chloroprene rubber tubes (available from A6 company), and the output decline rate of the fuel cell system was determined in the same manner as in Example 1.

### Comparative Example 4

The mass ratio α of eluted impurities was detected in the same manner as in Example 1, except that the tank test articles were prepared from a polyoxymethylene (POM) tank (available from B5 company), and the output decline rate of the fuel cell system was determined in the same manner as in Example 1.

### Comparative Example 5

The mass ratio α of eluted impurities was detected in the same manner as in Example 1, except that the tank test articles were prepared from a polyethylene telephthalate (PET) tank (available from B6 company), and the output decline rate of the fuel cell system was determined in the same manner as in Example 1.

The results of the above are shown in Table 1 and the graph in FIG. 3. The “<0.1” in the table means that the elution amount was less than 0.1 ppm.

TABLE 1

| | Material | | Material | | weighted | Output |
|---|---|---|---|---|---|---|
| | of tank | Elution | of tube | Elution | average of | decline |
| | test | amount | test | amount | elution | rate |
| | articles | (ppm) | articles | (ppm) | amount (ppm) | (%) |
| Ex. 1 | PE | 1.6 | Silicone | 1.8 | 1.6 | 3.6 |
| | | | rubber | | | |
| Ex. 2 | PE | 1.6 | Fluorine | 20 | 5.3 | 5.3 |
| | | | rubber | | | |
| Ex. 3 | PE | 1.6 | PFA | <0.1 | 1.3 | 2.4 |
| Ex. 4 | PP | 17 | Silicone | 1.8 | 14.0 | 5.1 |
| | | | rubber | | | |
| Ex. 5 | Modified | 6.7 | Silicone | 1.8 | 5.7 | 4.1 |
| | PPE | | rubber | | | |
| Ex. 6 | PPS | <0.1 | Silicone | 1.8 | 0.4 | 2.3 |
| | | | rubber | | | |
| Com. | PE | 1.6 | EPDM | 251 | 51.5 | 36.7 |
| Ex. 1 | | | | | | |
| Com. | PE | 1.6 | PE | 114 | 24.1 | 29.8 |
| Ex. 2 | | | | | | |
| Com. | PE | 1.6 | CR | 163 | 33.9 | 21.2 |
| Ex. 3 | | | | | | |
| Com. | POM | 77 | Silicone | 1.8 | 62.0 | 23.4 |
| Ex. 4 | | | rubber | | | |
| Com. | PET | 29 | Silicone | 1.8 | 23.6 | 12.8 |
| Ex. 5 | | | rubber | | | |

Table 1 and the graph thereof in FIG. 3 show that when the mass ratio α of eluted impurities exceeds 20 ppm, the output decline rate of the fuel cell system increases sharply. Therefore, by using a material in which the mass ratio α of eluted impurities is less than or equal to 20 ppm to form the collector and fluid flow channels, the decline in output over time of the fuel cell system can be suppressed.

### INDUSTRIAL APPLICABILITY

According to the present invention, it is possible to suppress the decline in output over time of fuel cell systems including a direct oxidization fuel cell such as DMFC. In particular, many consumer power generation devices such as those for outdoor use are not used on a regular basis, but used with long intervals. Even in such a case, it is possible to suppress the decline in output due to elution of organic substances from the collector and other components into the circulating fluid remaining in the fuel circulation system. Therefore, deterioration in performance over time of fuel cell systems, which are used in various patterns, can be suppressed.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: Fuel cell system, 12: Fuel cell, 14: Air pump, 16: Fluid feed pump, 18: Collector, 20: Controller, 22: First fluid flow channel, 24: Second fluid flow channel, 26: Third fluid flow channel, 28: Fuel tank, 30: Anode, 32: Cathode, 34: Electrolyte membrane, 36: MEA, 38, 40: Gasket, 42: Anode-side separator, 44: Cathode-side separator, 46: Fuel flow channel, 48: Oxidant flow channel, 50: Current collector plate, 54: End plate, 58: Cathode catalyst layer, 60: Cathode diffusion layer, 62: Anode catalyst layer, 64: Anode diffusion layer, 70: Cell

1. A fuel cell system comprising:
a fuel cell configured to consume a fuel and generate electric power;
a fuel feeder for feeding a circulating fluid including the fuel to the fuel cell;
a collector for collecting the circulating fluid discharged from the fuel cell, the circulating fluid including the fuel unconsumed by the fuel cell;
a first fluid flow channel connecting the fuel cell with the collector;
a second fluid flow channel connecting the collector with the fuel feeder; and
a third fluid flow channel connecting the fuel feeder with the fuel cell;
a ratio M2/M1 of a mass M2 to a mass M1 being less than or equal to 20 ppm in terms of hexadecane, where the mass M1 is a total mass of the collector, the first fluid flow channel, the second fluid flow channel and the third fluid flow channel, and the mass M2 is a mass of organic substances eluted into the circulating fluid or an equivalent for the circulating fluid, while the collector, the first fluid flow channel, the second fluid flow channel and the third fluid flow channel are immersed in the circulating fluid or the equivalent at a temperature TH1 for a time period TM1.

2. The fuel cell system according to claim 1, wherein a mass M3 of the circulating fluid or the equivalent is 20 times or more and 40 times or less as much as the mass M1, the temperature TH1 is 60° C. or higher and 80° C. or lower, and the time period TM1 is 40 hours or more and 60 hours or less.

3. The fuel cell system according to claim 1, wherein the collector, the first fluid flow channel, the second fluid flow channel and the third fluid flow channel each comprise a molded resin.

4. The fuel cell system according to claim 1, wherein the equivalent is an aqueous solution containing 2 mass % of methanol and 300 ppm by mass of formic acid, and having a power of hydrogen of 3.

5. A fuel circulating system for fuel cell system, comprising:
a collector for collecting a circulating fluid discharged from a fuel cell, the circulating fluid including unconsumed fuel;
a first fluid flow channel connecting the fuel cell with the collector;
a second fluid flow channel connecting the collector with a fuel feeder for feeding the circulating fluid to the fuel cell; and
a third fluid flow channel connecting the fuel feeder with the fuel cell;
a ratio M2/M1 of a mass M2 to a mass M1 being less than or equal to 20 ppm in terms of hexadecane, where the mass M1 is a total mass of the collector, the first fluid flow channel, the second fluid flow channel and the third fluid flow channel, and the mass M2 is a mass of organic substances eluted into the circulating fluid or an equivalent for the circulating fluid, while the collector, the first fluid flow channel, the second fluid flow channel and the third fluid flow channel are immersed in the circulating fluid or the equivalent at a temperature TH1 for a time period TM1.
